(19) United States
(12) Patent Application Publication
(10) Pub. No.: US 2008/0021758 A1
(43) Pub. Date: Jan. 24, 2008

(54) Responsibility determination

(76) Inventors: Jan Teichmann, Neustadt/W (DE); Dirk Henrich, Wiesloch (DE); Jan Richert, Mannheim (DE); Thorsten Scheyter, Dielheim (DE); Christian Peter Haas, Heidelberg (DE); Christoph Lange, Ostringen (DE); Martin Rogge, Osteringen-Eichelberg (DE); Marita Kruempelmann, Dielheim (DE)

Correspondence Address: KENYON & KENYON LLP, ONE BROADWAY, NEW YORK, NY, 10004, US

(21) Appl. No.: 11/481,737

(22) Filed: Jul. 5, 2006

(51) Int. Cl. G06F 15/02

(52) U.S. Cl. 705/9

(57) ABSTRACT

System and methods are described for automatically determining the responsible agent for a given task. Using a task grammar, a task constructor constructs a request description. A responsibility request, including the request description, is formulated. A rules engine queries a database and determines, given the request description, the responsible agent for the given task by matching the request description with a task description in the database and returning the responsible agent associated with the task description.

### BACKGROUND

Today, organizations suffer in many ways from a lack of precise determination of who is responsible for what tasks. In small companies, one person often handles three or more tasks or oversees an entire department of tasks. In large companies, employees often focus their efforts in very specialized tasks. In either case, properly forwarding a task to the appropriate person can be difficult. The inefficiencies found in additional time and effort spent routing tasks to the appropriate people can cost companies millions of dollars.

When a task needs to be performed, several obstacles stand in the way of efficient performance of that task. First, the employee creating a task to be performed needs to determine who to assign the task to. Companies that may have well developed roles and task responsibilities often rely on methods such as organizational charts kept on paper or word of mouth to forward tasks to the appropriate people. Paper charts quickly become obsolete because of changes in employee structures, new hires, or employees leaving the company. Relying on word of mouth fails because not every employee understands the inner working of all departments and finding the few employees with the specific area of knowledge can be difficult in large companies.

Second, tasks can become lost and remain incomplete as the task creator searches for the proper person to perform the task and subsequently forgets about the task. Third, highly specialized tasks may be improperly routed by individuals who are unfamiliar with the precise nature of the task to be performed. In very large organizations, several individuals may perform very similar tasks. For example, anyone in a company's customer service department may field calls related to a particular software product. However, because of specialized experience, one or more individuals may be particularly suited to field customer questions about that product. A second, perhaps less suited customer service agent may be unfamiliar with the product and thus provide inadequate assistance, may provide incorrect information about the product, or may spend time fielding the customer's question, only to eventually forward the question to the appropriate individual once it becomes apparent that his knowledge is insufficient.

Efficient task routing can directly impact a company's bottom line. Proper responsibility determination can lead to greater employee productivity because employees do not waste valuable resources matching each task with the most suitable employee to perform the task. Furthermore, an employee consistently receiving a specialized task builds efficiency through repetition. Reducing the time to process tasks builds customer satisfaction and loyalty, reduces errors, increases sales, etc.

Electronic solutions suffer from various problems as well, such as a lack of flexibility in how tasks may be defined and how agents may be designated as responsible for given tasks. A central feature of Employee Resource Management (“ERM”) software is the workflow. Workflows can track the progress of various task completions. Tasks within a workflow typically follow a predefined path from employee to employee until the task is completed. For example, a workflow may outline the steps necessary to introduce a hew hire to the company. The order of tasks may include: (1) the human resources manager to greet the new employee; (2) the security officer to create access keys; (3) the information systems department to set up the employee's computer and associated accounts; and (4) the human resources manager to process the new employee's medical plan forms. Each step in the workflow requires determining the person responsible for the tasks at that step of the workflow. The responsible agents may be hard coded as part of the workflow. When responsibilities of the responsible agents change, the workflows must be manually updated. Unless constant vigilance is kept for all workflows, the flow of steps in completing the various tasks is likely to be interrupted because a responsible agent may be designated that does not currently take responsibility for the given task.

In addition, workflows include predefined tasks. Each time a new task is identified, a new workflow needs to be constructed. Due to the complexity of ERM systems, and the fact that they often interconnect various other systems, defining new tasks can be time consuming and expensive. The workflow system may need to be shutdown as well while updates are made.

Thus, a streamlined responsibility determination system and method is needed that can consistently and automatically track tasks and their responsible agents and determine, given a particular context, who the responsible agent is for that task. In addition, a flexible task definition method and system is required. Further, a system which allows new tasks to be defined without much effort and without interrupting system services is desired.

### BRIEF DESCRIPTION OF THE DRAWINGS

FIG. 1 shows a block diagram of the system of the present invention.

FIG. 2 depicts an exemplary responsibility table of the present invention.

FIG. 3 depicts exemplary responsible agent requests of the present invention.

FIG. 4 depicts a flowchart of illustrative steps of the present invention.

FIG. 5 depicts an exemplary responsibility table of the present invention.

FIG. 6 depicts an exemplary front end of a task constructor.

FIG. 7 depicts an alternate embodiment of the present invention.

### DETAILED DESCRIPTION

Embodiments of the present invention provide systems and methods for automatically determining, at run time, the agent responsible for a particular task. A task description describes a task to be performed. The task description may be constructed by a task constructor using a task grammar. A task grammar may include arbitrary elements that may be predefined or defined at run time, leading to the definition of limitless numbers of tasks. A rule maps task descriptions with the agents who are responsible for performing the described task. A request description contains the description of a proposed task in a responsibility request, the request serving as a mechanism to query the system to determine the responsible agent for the particular proposed task. The task description of the various rules may be constructed using the task grammar. A task constructor may predefine, or construct at run time, arbitrary task descriptions and request descriptions using the elements of the task grammar. The update processor combines a rule task description with a responsible agent, leading to the definition of limitless numbers of rules at run time. A rules engine matches a request description of a proposed task with the various rule task descriptions of the various responsibilities rules to locate an agent responsible for performing the received task. In this way, a flexible system and method is contemplated that allows tasks to be defined generally at run time and automatically resolves to rules that define the agents responsible for performing the associated tasks.

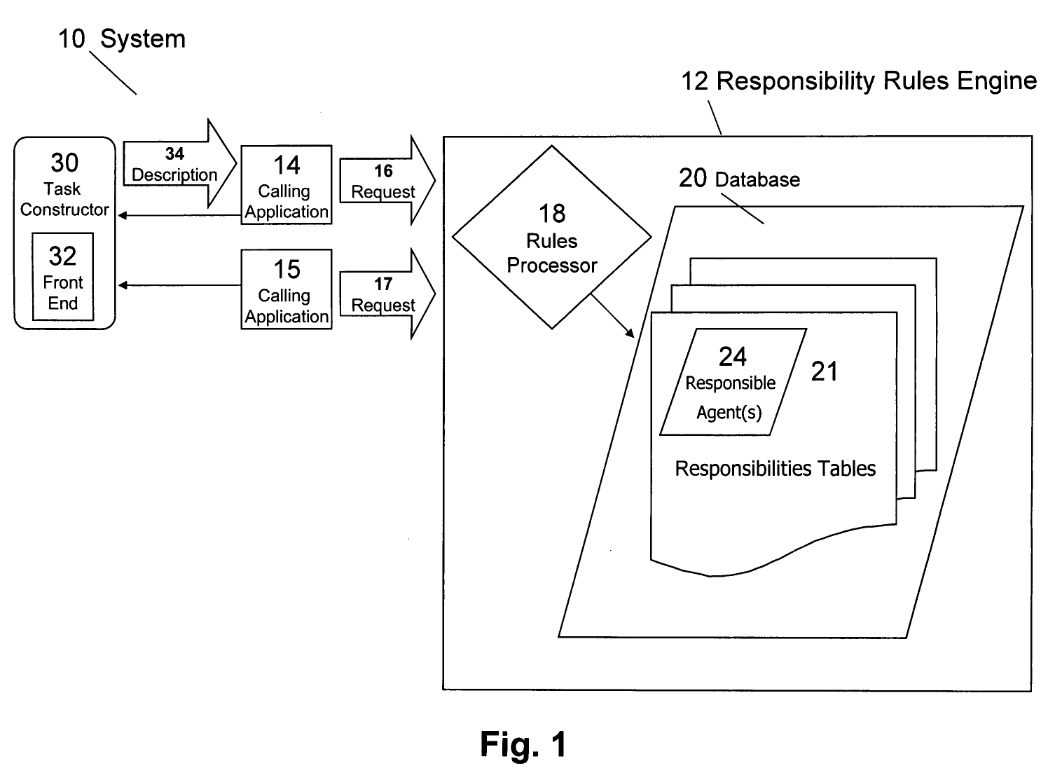

FIG. 1 depicts a block diagram of a system 10 of the present invention. The system 10 contains a responsibility rules engine 12 and calling applications 14 and 15 in communication with rules engine 12. The responsibility rules engine 12 may exist on a computing platform adapted to receive incoming requests 16 and 17, such as a server in a client-server environment. The calling applications 14 and 15 may be programs on computing platforms adapted to issue requests 16 to rules engine 12. The calling applications 14 and 15 may be client applications and may be connected to rules engine 12 over any suitable computing network. In practice, a number of calling applications 14 and 15 and responsibility rules engines 12 may vary as desired within the computing system; for the purposes of the present discussion, such implementation decisions are immaterial unless otherwise stated.

Description of the present invention begins with a description of a task grammar. A task grammar may include elements and grammar rules. Grammar rules define the structure of the task. Elements make up the individual building blocks that are assembled according to the grammar rules to make up either a task description or a request description. A user may define, at run time, arbitrary numbers of elements, thereby allowing for the construction of any arbitrary task. This flexibility permits the system to describe and process any task without predefining the tasks ahead of time. Of course, in practice, the system may include predefined task elements that may permit a task constructor to begin constructing tasks right out of the box.

Task grammar rules may be of arbitrary complexity, leading to complete flexibility in the types of tasks that may be described. A task grammar rule describes the way that grammar elements may be combined. In one embodiment, a rule may define that a task description or request description may be constructed by combining any triple of elements together. In another embodiment, another rule may allow a series of elements to be concatenated such that the first element of any series is element 1. In other words, rules may be arbitrary and may state that elements may be grouped and ordered in any appropriate fashion. Rules may be implemented in various ways, but unless stated, their implementation is immaterial to the description of this invention.

Grammar elements may be grouped into types, further adding to a grammar's flexibility. Grammar rules, in addition to being applied to elements, may be applied to types at the same time. To illustrate, for a grammar with 150 elements, a first type may include elements 1-100. A second type may include elements 101-150. A rule may be defined which allows any element of the first type to be paired with any element of a second type. Another rule may define that a task description or request description includes an arbitrary number of element pairs, just described, to be concatenated together. Yet another rule may state that element 1 may be paired with any element of the second type. Types and rules may be implemented in various ways, but unless stated, their implementation is immaterial to the description of this invention.

A task description or request description may be an actual set of task parameters, or elements, that define the task. Any particular parameter, as described, may contain a range of values. For example, a “Country” parameter may contain the possible values “U.S.” or “Canada.” A “Day of the Month” parameter may contain possible values ranging from 1 to 31. A task description may be constructed by appropriately selecting among the possible values for the parameters and verifying that the end result conforms to the grammar rules.

In practice, any grammar of arbitrary complexity may suffice that can be used to describe tasks. In one simple embodiment, the grammar may include fields and values. Values may be grouped together into groups and given a label. All of the labels of the value groups may themselves be grouped together to form a field group. A task description or request description may be constructed by forming a series of field/value pairs in which the field corresponds to the label of the value group that the value is a part of.

The table below depicts an exemplary set of fields and values for a task grammar of the present invention describing tasks for a corporation.

TABLE 1
Exemplary Grammar Elements

| FIELD | VALUE | VALUE | VALUE |
|---|---|---|---|
| Activity Type | Accounting | Hiring | Customer Service |
| Accounting Payroll | Print Pay Checks | Distribute Pay Checks | Add Employee |
| | Reimburse Employee | | |
| Accounting | Enter Daily Receipts | Audit Books | Create SEC Filing |
| Bookkeeping | into Ledger | | Statement |
| Hiring New Employee | Security Tasks | Computer Systems | HR Form Tasks |
| | | Tasks | |
| Hiring Security Task | Create Access Key | Circulate Photo to All | |
| | | Security Officers | |
| Hiring Computer | Set up Desktop | Create Password | Create Email Account |
| Systems Task | Computer | | |
| | Train New Employee | | |
| Hiring HR Forms Task | Process Medical | Process 401K Form | Process W2 and W4 |
| | Insurance Form | | Form |
| . . . | . . . | . . . | . . . |

In the current embodiment, a number of field/value pairs may be combined to define a task. For example, one task description or request description may be ([Activity Type=Accounting], [Accounting Payroll=Distribute Pay Checks]). Another task description or request description may be ([Activity Type=Hiring], [Hiring Computer Systems Task=Create Password]). In practice, any number of field/value pairs may be combined together according to the definition of the grammar elements. Also, in practice, the actual task descriptions and request descriptions may be represented in any appropriate format, including as an array of field/value pairs, as a text string of field/value pairs, etc.

Complex grammars may also be used. In one embodiment, the English language may be used to define grammars. The task constructor may allow the user to type in a natural language task description or request description and may use grammar rules to insure that the task description fulfills the rules of the English language. In this case, individual words may be the grammar elements. Parts of speech may be used to group grammar elements. Grammar Rules may include various levels of specificity. For example, the first level may combine sentences into paragraphs. Next, sentences may combine clauses. Finally, clauses may combine parts of speech. In this way, a task may be described arbitrarily by the use of the English language. Another exemplary grammar may be computer programming languages.

Tasks may be associated with data necessary to carry out the task. A task constructor may receive data to be processed by one responsible for a particular task. The task constructor may then formulate a task description or request description based on a task grammar and associate the task with the data to be processed.

Task data may be arbitrary. In one embodiment, task data for the ([Activity Type=Hiring], [Hiring Computer Systems Task=Create Password]) request description may be the name of the new employee, employee's user name, and the employee's identification number. The task data for the ([Activity Type=Accounting], [Accounting Bookkeeping=Audit Books]) request description may be all files and ledgers associated with accounting for that year. Still further, some tasks require no task data at all. For example, the ([Activity Type=Accounting], [Accounting Payroll=Distribute Pay Checks]) request description may not require any data to be processed.

In yet another embodiment, task descriptions and request descriptions may include a responsibility context and responsibility data. A responsibility context may be any arbitrary grouping of related tasks. For example, an international web retailer may need to confirm shopping carts of varying values from different countries. One individual may be designated to confirm shopping carts from Germany less than [symbol] 10,000. Another may confirm shopping carts from Germany greater than [symbol] 10,000. Another may confirm U.S. carts between $2,000 and $8,000. Finally, another may confirm U.S. carts from any territory outside of the 50 states, regardless of the value. A responsibility context may be the general task of confirming shopping carts while the specific parameters of the task may be the responsibility data. In another example, as part of a task scheduling suite, tasks may be organized into groups based on the amount of time it takes to perform the tasks. A first responsibility context may include all tasks that require five minutes or less to complete. The scheduling suite may schedule the responsible agents to perform these short tasks to fill small gaps in a schedule to achieve maximum efficiency.

A responsibility context may be thought of as a classifying mechanism that creates a subset of rules that is applicable to the task being described. Each particular rule may contain data that further specifies the task within the responsibility context. For example, A “manufacturing” responsibility context in a request description may permit the rules engine to exclude rules not concerning manufacturing from its search to match the request description with the appropriate task description. Existence of the “manufacturing” responsibility context in effect allows the rules engine to classify all manufacturing rules together.

Multiple layers of responsibility contexts may be constructed to further categorize tasks. Each successive specific responsibility context permits the rules engine to categorize rules in increasingly finer ways. For example, the manufacturing responsibility context may contain a subcontext for “site logistics” and “production.” Within cite logistics, the task types may include “move equipment” and “perform diagnostics.” The production subcontext may include task types “set up” and “deliver materials.” The precise number of levels of specificity depends on the particular implementation of the invention and is immaterial to this description. Each level of specificity may permit the rules engine to narrow the scope of its search, thereby returning the matching result more quickly.

The user may employ a task constructor 30 to formulate task descriptions or request descriptions. A task constructor may be a separate computer program module (as shown in FIG. 1) or a computer program integrated with the calling applications 14 and 15. In one embodiment, the task constructor may contain a front end 32 which may be an interface to the user. This interface may allow the user to construct task descriptions and request descriptions, depending on whether a new task is being defined or whether a new request is being created. Alternatively, the constructor 30 may simply receive data for a task description or request description and construct the task without user intervention, such as in an automated fashion. In one embodiment, the calling application 14 may implement one instance of the task constructor method. The calling application may call this constructor and receive back a fully constructed task description or request description 34.

For the user front end constructor 30, the user interface may allow a user to specify each subpart of the task description or request description. In one embodiment, a front end may include an input text box. The user may enter text using a keyboard. The constructor 30 may receive the inputted text and verify that it conforms to the format of the grammar. The English grammar may be used here. Each word may be categorized into parts of speech, and the constructor may apply grammar rules of the English language to check if the text is a well formed sentence.

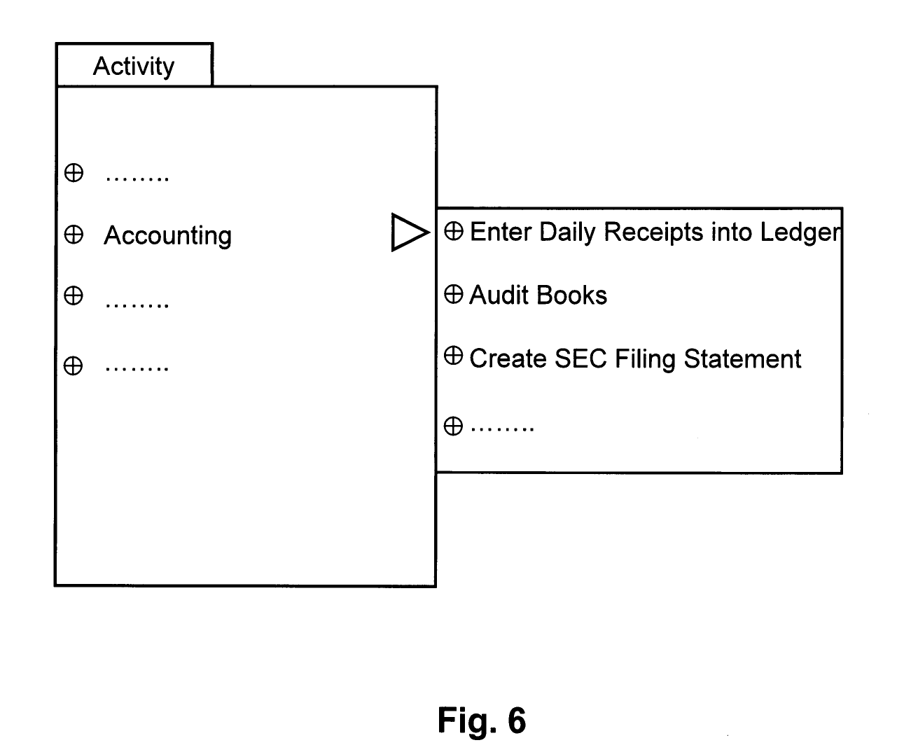

In another embodiment shown in FIG. 6, a series of drop down boxes may present the user with possible values for field/value pairs that the user may choose from. The first box may allow the user to choose the type of activity. The next box may change depending on what value the user chooses for the activity in the first box. In this way, the user may fully specify a task description or request description from a set of preselected values. In practice, the user interface front end may be accomplished in various ways; implementation of the front end is immaterial to this description.

Turning back to FIG. 1, the calling application may formulate and send a responsibility request to the responsibility rules engine. The calling application 14 may construct a responsibility request 16 from the request description 34 received from the task constructor 30. This request may be sent to the responsibilities rules engine 12.

The responsibility rules engine 12 may include a rule processor 18 adapted to receive incoming requests 16 and to query a database 20 to perform the responsibility determination. In practice, various architectures may exist for rules engine 12. The responsibility rules engines may exist as separate computing platforms, each with their own databases 20. In this case, the databases 20 may contain additional data synchronization features to insure that each database contains the same information as the other databases. Alternatively, there may be a single database 20 which serves data for all of the responsibility rules engine 12. Still further, instead of existing as separate servers across a computing network, the responsibility rules engine 12 may be computing components that exist as part of the calling applications themselves.

The database 20 may include various responsibilities tables 21. The rules processor 18 may receive a request description and search the tables 21 to look for a matching task description. Upon finding a match, the rules processor may retrieve the responsible agent listed for the task description and return it to the calling application 14.

Tables 21 may be organized in arbitrary ways, and matching may be done arbitrarily as well. Tables 21 may include entire task descriptions and their associated responsible agents or may be organized to facilitate searching. In one embodiment, tables 21 may include a single table that includes one field representing the task description and one field representing the responsible agent. An exemplary table is shown below.

TABLE 2
Single Responsibilities Table

| | RESPONSIBLE |
|---|---|
| TASK DESCRIPTION | AGENT |
| ([Activity = Accounting], [Accounting | John Smith |
| Bookkeeping = Auditing]) | |
| ([Activity = Hiring], [Hiring Security Task = | Jane Doe |
| [Circulate Photo to All Security Officers]) | |

A search using the single responsibilities table may attempt to match the entire request description with each task description in the first field of the table. Alternatively, in practice, an arbitrary number of tables may be used. For example, task descriptions may be inherently grouped such that the rules processor need to simply search the table corresponding to the task group to which the task description belongs.

Tables may be organized in other ways that may facilitate searching. In another embodiment, tables may be organized in a hierarchical way, such that each subpart of the task description may exist as a separate table with pointers to other tables that include information for other subparts. An exemplary table is shown below.

TABLE 3
Complex Responsibilities Tables
TABLE 1

| | |
|---|---|
| Activity = Accounting | Table 2 |
| Activity = Hiring | Table 3 |

TABLE 2

| | |
|---|---|
| Accounting Payroll = Distribute Pay Checks | John Smith |
| Accounting Bookkeeping = Audit | Jane Smith |

TABLE 3

| | |
|---|---|
| Hiring Security Task = Circulate Photo to All | John Doe |
| Security Officers | |
| Hiring computer systems task = Set Up Desktop | Jane Doe |
| Computer | |

Given that the request description task is ([Activity=Accounting], [Accounting Bookkeeping=Audit]), the system may first look in table one to match the first subpart of the request description, [Activity=Accounting]. Instead of a responsible agent in the accompanying table field, the table may include a pointer, such as the table pointing to Table 2 in the example above. In practice, implementation of the format of task descriptions and the tables 21 may be performed in to best way to suit the specific system implemented and are immaterial for the purposes of this description.

A match algorithm of the rules processor 18 may depend on the format of the task description. For the embodiment described above, a pair by pair matching scheme may be employed where the field and values must correspond in order for the individual pairs to be equal. If the task descriptions are textual (as represented in the examples employing the English grammar above), a text string comparison function may be used. Where task descriptions are represented in data structures, task description functions may be employed to match the request descriptions with the task descriptions in the tables 21. For example, task descriptions may consist of an array data structure of field/value pairs. In this illustration, the request description and task description may be equal even though the ordering of pairs in the array differs. Therefore, in comparing a request description against one of the task descriptions in the tables 21, the comparison function must search for each of the pairs of the request description in turn.

In other embodiments, matching may also employ fuzziness. Using fuzziness allows a request description and task description to be matched despite them not being strictly equal. The matching algorithm may contain thresholds under which matches that differ may be deemed to be equal. For example, a match algorithm may receive a request description and a task description, the request description and task description differing only that the request description contains a field/value pair not found in the task description. The request description and task description may be deemed to be equal. In another example, a match algorithm may receive both a request description and task description in the English language in accordance with an embodiment described above. The matching algorithm may allow for spelling errors by augmenting each word with a set of common misspellings taken from a preselected misspelling dictionary. Then, the matching algorithm may compare each augmented list of words in the first sentence with all augmented words in the second sentence. In practice, the implementation of matching algorithms may vary as appropriate and are immaterial for purposes of this description.

Furthermore, in other embodiments, matching may look to see whether the request description meets the condition of the responsibility rules. In this embodiment, a responsibility rule may contain a condition to be satisfied. The matching algorithm may see whether the data of the request description meets the rule. The condition of a responsibility rule may require that certain data fall within a particular range of values or that certain data have a specific value. The data of the request description would be checked to see whether it either falls within the acceptable range or has the value required by the rule. To illustrate, a rule may state that an agent can process all purchase orders between $1,000 and $10,000. The range may be specified in the “Purchase Order Value” field of the rule condition. An incoming request description may contain data indicating a purchase order of $2,000, specified in the “Purchase Order Value” field. The matching algorithm may select these two fields and determine that the request description data falls within the range specified by the rule. In practice, matching request description data against responsibility rule conditions may be implemented in any suitable way; implementation level detail is immaterial to the description of this invention.

Once the rules processor 18 locates the responsible agent(s) 24 responsible for the request description in the request 16, the agent or agents may be returned to the calling application 14. The task data associated with the request 16 may then be forwarded to the responsible agent(s).

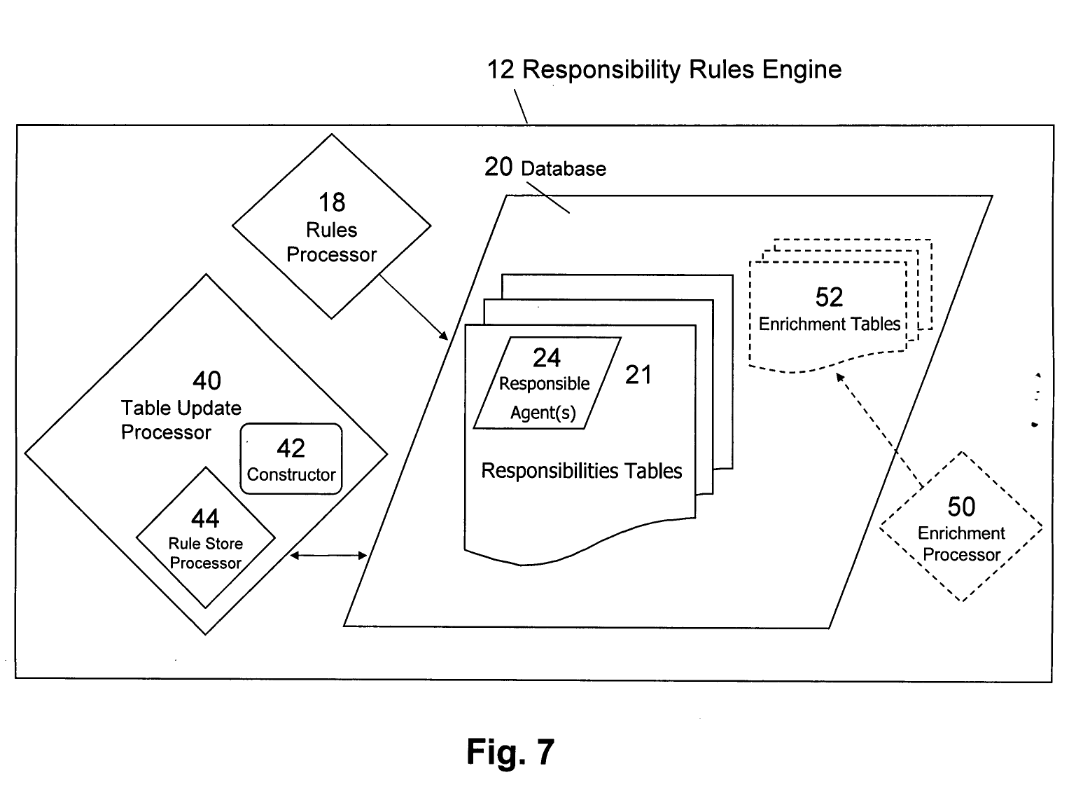

In one embodiment, shown in FIG. 7, the responsibilities rules may be updated at run time. A table update processor 40 may contain a constructor 42 and a rule store processor 44. The table update processor may be connected to the database 20. The table update processor may receive a request to add a new responsibility rule to the database 20. The update processor 40 may invoke the task constructor 40 to create a task description for the desired responsibility rule. The update processor 40 may associate the created task description with a responsible agent to form a responsibility rule. The rule store processor 42 may receive the responsibility rule and store the rule in the appropriate table(s) 21.

In yet another embodiment, a responsibility table 21 may contain responsibility data needed to further specify which task within a responsibility context to perform. For example, responsibility data for the responsibility context “confirm shopping carts” may consist of “Germany, < [symbol] 10,000” or “U.S., any territory outside the 50 states”.

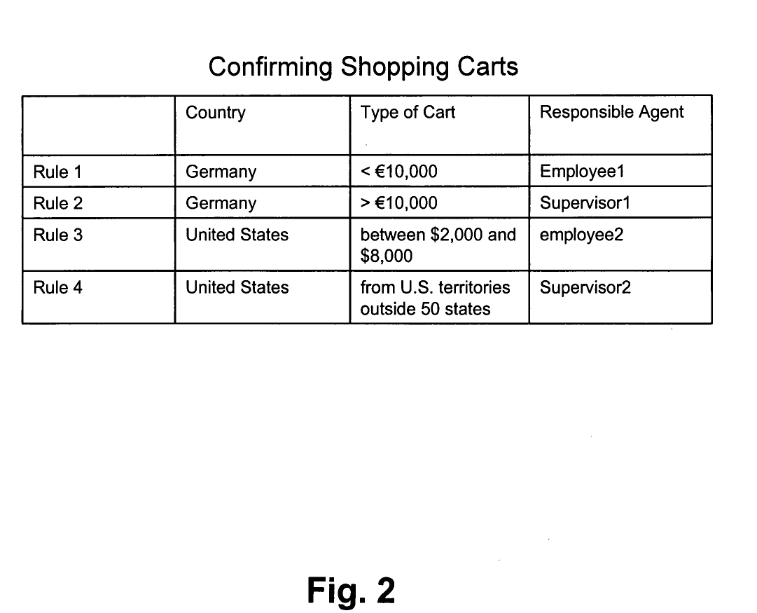

The responsibility table 21 may also associate a responsible agent 24 with the responsibility data of the responsibility rule. The responsible agent may be the individual designated to handle all tasks within the responsibility context for the specific responsibility data. For example, employee 1 in FIG. 2 may be the responsible agent for confirming all shopping carts from Germany with a value less than [symbol] 10,000.

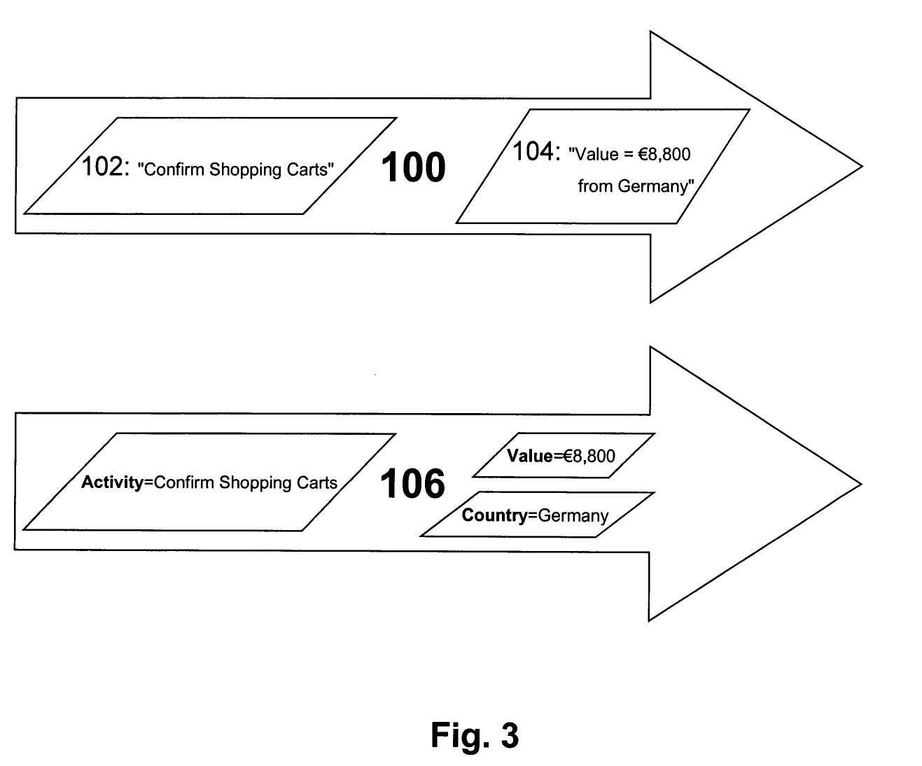

Returning to FIG. 1, the calling application 14 may initiate sending the responsible agent request 16 to the responsibility rules engine 12 in response to an event. For example, upon receiving an electronic shopping cart from the web store in Germany with a value of [symbol] 8,800, the calling application may seek the responsible agent responsible for processing the shopping cart. Exemplary responsible agent requests are shown in FIG. 3. Request 100 is shown containing a responsible context and responsibility data. Another form of the request is shown as 106. Returning to FIG. 1, the responsible agent request 16 may contain a responsibility context and responsibility data. For example, the request 16 may contain “confirm shopping carts” and “Germany, < [symbol] 10,000”.

Upon receiving the responsible agent request 16, rules engine 12 may use the responsibility context found in the responsible agent request 16 as an index to select the correct responsibility table. Tables 21 may include an index table which contains mappings between responsibility contexts and pointers to the tables that contain rules for that responsibility context. The rules engine 12 may perform a look up into the index table with the received responsibility context and receive a pointer to the appropriate table to be searched. The rules processor 18 may then query that table to match the responsibility data with a rule in that table. The responsibility rules engine 12 may return the responsibility agent associated with the responsible agent request 16 upon matching the responsibility data in the request 16 with the responsibility data in the responsibility table. The calling application 14 may then forward the shopping cart related to the responsible agent request 16 to the responsible agent for processing.

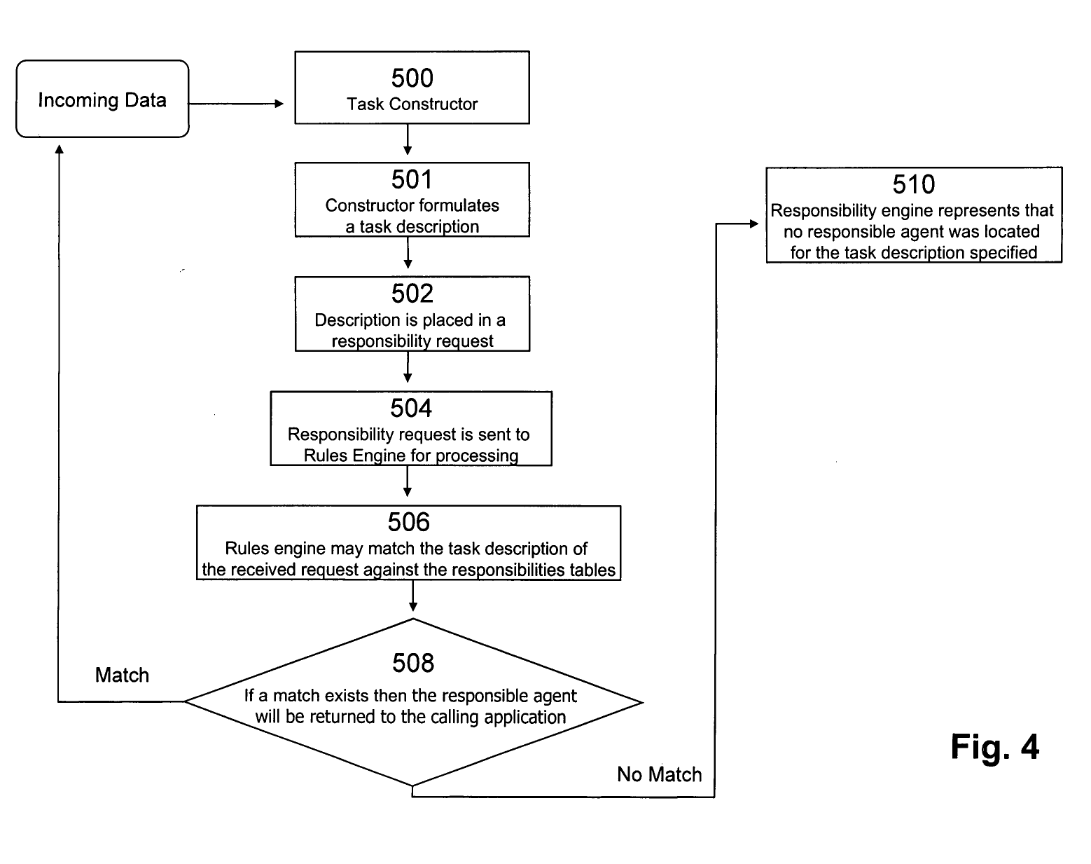

FIG. 4 depicts a flowchart of general steps of the present invention. In step 500, a task constructor may receive data to be formulated into a request description. The constructor may apply task grammar construction rules to appropriately specify the task to be described in step 501. As described above, the task grammar may range in complexity. The task constructor may either receive input from a user via a user front end or may generate a request description from data input from another process. In step 502, the request description may be placed into a responsibility request. In step 504, the responsibility request may be sent to a responsibility rules engine for processing. The rules engine may match the request description of the received request against a task description in the responsibilities tables in step 506. In step 508, if a match is found, the responsible agent associated with the task description may be returned to the calling application. Otherwise, in step 510, a value may be returned that represents that no responsible agent was located for the task description specified.

In an alternate embodiment, referring to FIGS. 1 and 7, the calling application 14 may enrich the responsibility data prior to sending the responsible agent request 16 to rules engine 12. Rule enrichment may be necessary, for example, where the request description lacks sufficient information to select a proper responsibility rule. The rules engine 12 may contain an enrichment processor 50. When a responsibility request 16 is received, the enrichment processor 50 may query enrichment tables 52 within database 20 to locate ways that the request description may be augmented. (In practice, the enrichment rules may exist in run time memory, and no reference to tables may be necessary.) The enrichment tables 52 may contain augmentation rules. An augmentation rule condition may include conditions that need to be satisfied so that the request description may be augmented. The augmentation rule may also contain augmentation data that is used to augment the request description once the augmentation condition is satisfied. Request descriptions may be augmented by adding the augmentation data to the data of the request description. The enrichment processor may exist as part of the rules engine 12 (as shown) or as part of calling applications 14 or 15.

To illustrate, the calling application 14 may seek a responsibility agent to process an incoming shopping cart. The shopping cart may contain the customer's name, street address, and city (Munich for example), but may lack the country. Without the country, it may be impossible to properly route the shopping cart for processing. A request may be sent to the rules engine 18 containing a request description with the information known. Upon receiving the request description the rules engine 18 may send the request to the enrichment processor 50. The enrichment tables 52 may contain a rule that specifies that the city Munich is in the country Germany. The enrichment processor 50 may examine the received request description to see if it includes Munich in the portion corresponding to a city location. The enrichment processor 50 may enrich the responsibility data by filling in the country of Germany. In addition to automatic enrichment, the enrichment processor may use human intervention to augment the request description. In one embodiment, the user may be presented with a display showing the request description. A front end similar to one used in the task constructor may be used. In practice, various methods of augmentation may be used, either automatic or with human input; implementation level detail is immaterial to the description of this invention.

In an alternate embodiment, responsible agent requests may proceed in a forward or reverse direction. In the forward direction, the calling application may request the agent responsible for a specific task. In the reverse direction, the calling application may request all specific tasks that an agent is responsible for. The reverse query may occur, for example, when a company wishes to temporarily assign an agent's responsibilities to another person while the agent goes on vacation. In this case, the responsibilities request 17 may contain the responsible agent.

Upon receiving the responsibilities request 17, the rules engine 12 may initiate a look up in the database 20 for all entries containing the responsible agent. The rules engine 12 may select each responsibility table in turn and select any rule which contains the responsible agent in the responsible agent field. The rules engine may send back all associated task descriptions where the responsible agent matches the received responsible agent.

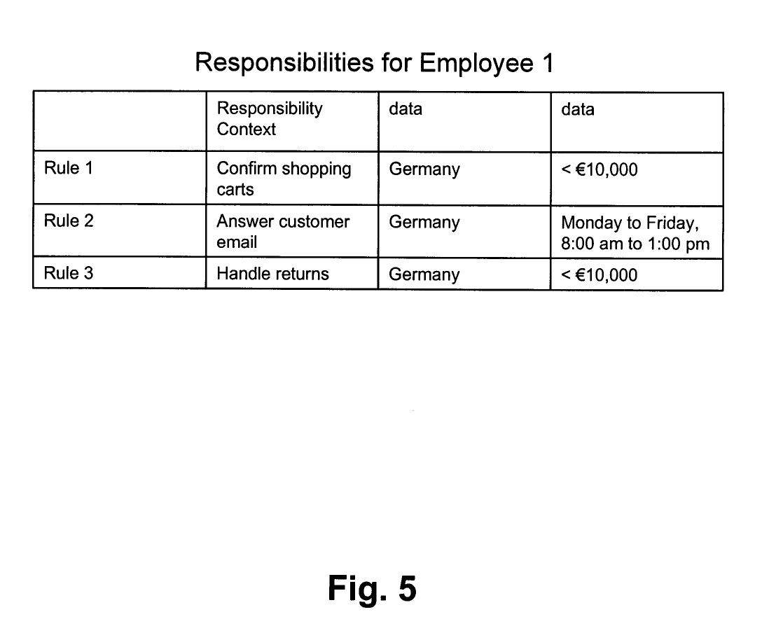

In yet another embodiment, the database 20 may contain responsibility tables which contain all responsibility rules associated with a particular agent. In this case, the responsibility tables may exist in the form depicted in FIG. 5. In this instance, the rules engine, upon receiving the responsibilities request 17, may use the responsible agent as an index to select the appropriate table. The rules engine may then return the rules found in that table to the calling application 14.

In another embodiment, each rule may contain a default agent who is responsible for the specific task. In one embodiment, one table of database 20 may contain every responsibility rule found in the system 10. This table may designate an agent who will be returned as the responsible agent if the rules engine is unable to find a responsible agent for the rule in the responsible agent request. In another example, the table shown above may be augmented to include a default agent responsible at each level of the responsibilities rule hierarchy for all tasks in that level.

TABLE 4
Complex Responsibilities Tables with Default Agents
TABLE 1

| | |
|---|---|
| Activity = Accounting | Table 2 |
| Activity = Hiring | Table 3 |
| Activity = Default | Chief Operations Officer |

TABLE 2

| | |
|---|---|
| Accounting Payroll = Distribute Pay Checks | John Smith |
| Accounting Payroll = Default | Chief Financial Officer |
| Accounting Bookkeeping = Audit | Jane Smith |
| Accounting Bookkeeping = Default | Chief Financial Officer |

TABLE 3

| | |
|---|---|
| Hiring Security Task = Circulate Photo to All | John Doe |
| Security Officers | |
| Hiring Security Task = Default | Chief Security Officer |
| Hiring computer systems task = Set Up | Jane Doe |
| Desktop Computer | |
| Hiring computer systems task = Default | Chief Technical Officer |

In yet another embodiment, the rules engine 12 may perform a series of look up sequences to locate an appropriate responsible agent. Upon receiving a responsible agent request 16, the first look up sequence may locate the responsible table corresponding to the responsibility context of the request. Finding no responsible agent, the rules engine 12 may execute a fallback sequence. The rules engine may maintain a preselected set of look up sequences for each rule. For example, unable to find the responsible agent to confirm a shopping cart from Germany of [symbol] 8,800, the rules engine may next search to find the agent responsible for confirming shopping carts less than [symbol] 10,000 for the neighboring countries of Germany, such as Austria. Finding nothing, the rules engine 12 may then search for anyone responsible for confirming shopping carts from any country in the European Union.

In another embodiment, late hierarchy resolutions may be used. In late hierarchy resolution, the responsibilities for all organizational subunits may be determined at query time, instead of explicitly recording them in the database. For example, a low level employee may perform the daily task of filling out purchase order forms in a purchasing department. Final responsibility to sign off on all purchase orders may, however, lie with the purchasing manager. A query in the “purchase order fulfillment” responsibility context for an agent responsible for purchases for new computers may yield the low level employee who is responsible for completing the forms. Along with this responsible agent, the database entry may contain a pointer to the individual up the chain of command who reviews the purchase orders. The reviewing agent entry may further contain a pointer to yet another higher level manager responsible for some aspect of the computer purchase order. Finally, queries up the chain of command may yield the purchasing manager, who is ultimately responsible for the purchase order.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A system for automatically determining a responsible agent comprising:
a task constructor for constructing a request description according to a task grammar;
a calling application for issuing a responsibility request, the responsibility request comprising the request description;
a responsibilities engine for receiving the responsibility request;
a database comprising responsibility rules, the responsibility rules further comprising mappings between task descriptions and responsible agents; and
a rule processor for querying the database to determine the responsible agent from the request.

2. The system of claim 1 further comprising:
an enrichment processor for enriching the request description.

3. The system of claim 1 further comprising:
the database further comprising a default responsible agent returned when no agent is located for the responsibility request.

4. The system of claim 1 further comprising:
the rule processor further engaging multiple look up sequences to locate the responsible agent.

5. A system for automatically determining the responsibilities of a responsible agent comprising:
a calling application issuing a responsibility request, the responsibility request comprising a responsible agent;
a responsibilities engine for receiving the responsibility request;
a database comprising mappings between responsible agents and task descriptions; and
a rule processor for querying the database to determine, from the responsible agent, the associated task descriptions for the responsible agent.

6. A method for automatically determining a responsible agent comprising:
constructing a request description from a task grammar;
sending a responsibility request from a calling application to the responsibilities engine, the responsibility request comprising the request description;
querying a database to locate the responsible agent associated with the responsibility context and responsibility data, the database comprising responsibility rules, the responsibility rules further comprising mappings between task descriptions and responsible agents;
matching the request description with the task descriptions of the responsibility rules; and
returning the associated responsible agent to the calling application.

7. The method of claim 6 further comprising:
enriching the responsibility request by:
matching data within the request description against a condition of an augmentation rule; and
augmenting the request description by adding the augmenting data of the augmentation rule to the task description.

8. The method of claim 6 further comprising:
returning a default agent if no responsible agent is found.

9. The method of claim 6 further comprising:
engaging in multiple look up sequences to locate the responsible agent by the rules processor.

10. A method for automatically determining responsibilities for a responsible agent comprising:
sending a responsibility request from a calling application to the responsibilities engine, the responsibility request comprising a responsible agent;
querying a database to locate the responsible agent associated with the responsibility context and responsibility data, the database comprising mappings between responsible agents and task descriptions;
matching the responsible agent; and
returning, for the responsible agent, the associated responsibility context and associated responsibility data to the calling application.
